(19) United States
(12) Patent Application Publication
(10) Pub. No.: US 2012/0117513 A1
(43) Pub. Date: May 10, 2012

(54) INFORMATION PROCESSING TERMINAL

(76) Inventor: Yuji Kawai, Osaka (JP)

(21) Appl. No.: 13/386,011

(22) PCT Filed: Jul. 14, 2010
(86) PCT No.: PCT/JP2010/004578

§ 371 Date: Jan. 19, 2012

(30) Foreign Application Priority Data
Jul. 21, 2009 (JP) 2009-169886

(51) Int. Cl. G06F 3/048

(52) U.S. Cl. 715/835

(57) ABSTRACT

Provided is an information processing terminal that can accurately obtain an image having the title of an application program displayed, and display an image that conforms to the content of the application program, on an application-program list. The information processing terminal (1) is provided with an inputting means (2) for accepting manipulation inputs, storage means (5) for storing application programs, a displaying means (7) that displays a list of application programs stored in the storage means (5). The information processing terminal (1) is also provided with a control means (3) that stores, into the storage means (5), the screen of the application program being displayed on the displaying means (7) in correspondence to the application program, when the inputting means (2) accepts a certain manipulation input when the application program is running.

### TECHNICAL FIELD

The present invention relates to an information processing terminal. More particularly, the present invention relates to an information processing terminal that executes an application program.

### BACKGROUND ART

In recent years, information processing terminals have become able to execute various application programs. For example, in portable information processing terminals, it is possible to describe applications with programs such as Java (registered trademark) and BREW, so that it is possible to create, embed, and execute game programs or practical application programs.

Such information processing terminals display not only the titles of the application programs but also icon images stored in association with the application programs, when the information processing terminals display a list of the application programs. In this way, the information processing terminals can present the functions of the application programs to users so that the user can easily understand the contents of the application programs, before the information processing terminals execute the application programs.

FIG. 1 illustrates an application program list screen in a conventional information processing terminal.

Here, in application 3, an icon image intentionally that is generated by a creator who created the application program is embedded in advance. By acquiring the icon image at the time of installing application 3, the information processing terminal displays the icon image prepared by the application program on application program list screen 901.

On the other hand, when creating the application programs, creators do not embed icon images in applications 1, 2, and 4, and application program list screen 901 displays default icon images prepared in the information processing terminal.

However, the default icons are not associated with the application programs, so that there is such inconvenience that the users cannot understand the contents of the application program with a glance at the default icons.

For example, Patent Literature 1 discloses an information terminal apparatus that makes the contents of video data easier to understand by acquiring the title images of the video data through character recognition, reducing the sizes of the title images, and displaying a list of the title images.

### CITATION LIST

### Patent Literature

### PTL 1

Japanese Patent Application Laid-Open No. 2006-140603

### SUMMARY OF INVENTION

### Technical Problem

However, many title characters (title images) displayed when application programs are executed are designed as pictures expressing the atmospheres of the application program.

Accordingly, with the information terminal apparatus disclosed in Patent Literature 1, there is such concern that the characters cannot be recognized from the title images in the case of some designs and thus the acquisition of the title images of the application programs may fail. With this case, there is such a problem that users cannot determine the contents of the video data when the users glance at the displayed list of the video data.

It is therefore an object of the present invention to provide an information processing terminal capable of accurately acquiring a title image of an application program and displaying an image suitably reflecting the contents of the application program in a list of the application programs.

### Solution to Problem

An information processing terminal according to the invention includes: an input section that receives an operation input; a storage section that stores application programs; a display section that displays a list of the application programs stored in the storage section; and a control section that associates screens of the application programs displayed on the display section with the application programs and stores the screens in the storage section when the application programs are executed and the input section receives a specific operation input, wherein when the input section receives an operation of displaying the list of the application programs when the input section receives an operation of displaying the list the application programs.

### Advantageous Effects of Invention

According to the present invention, it is possible to accurately acquire the title image of an application program and display an image suitably reflecting the contents of the application program in a list of the application programs.

### BRIEF DESCRIPTION OF DRAWINGS

FIG. 1 is a diagram illustrating an example of an application program list screen in a conventional information processing terminal;

FIG. 2 is a block diagram illustrating the general configuration of an information processing terminal according to Embodiment 1 of the present invention;

FIG. 3 is a flowchart illustrating an operation of acquiring an image in which the title of an application program is displayed in the information processing terminal according to the above Embodiment 1;

FIG. 4 is a diagram illustrating a screen corresponding to the flow of the process by the information processing terminal according to the above Embodiment 1;

FIG. 5 is a diagram illustrating a data table stored in a storage section of the information processing terminal according to the above Embodiment 1;

FIG. 6 is a flowchart illustrating an operation of displaying a list of application programs in the information processing terminal according to the above Embodiment 1;

FIG. 7 is a diagram illustrating an example of an application program list screen in information processing terminal 1 according to the above Embodiment 1;

FIG. 8 is a block diagram illustrating the general configuration of an information processing terminal according to Embodiment 2 of the present invention; and

FIG. 9 is a flowchart illustrating an operation of acquiring an image in which the title of an application program is displayed in the information processing terminal according to the above Embodiment 2.

### DESCRIPTION OF EMBODIMENTS

Hereinafter, embodiments of the present invention will be described in detail with reference to the drawings.

### Embodiment 1

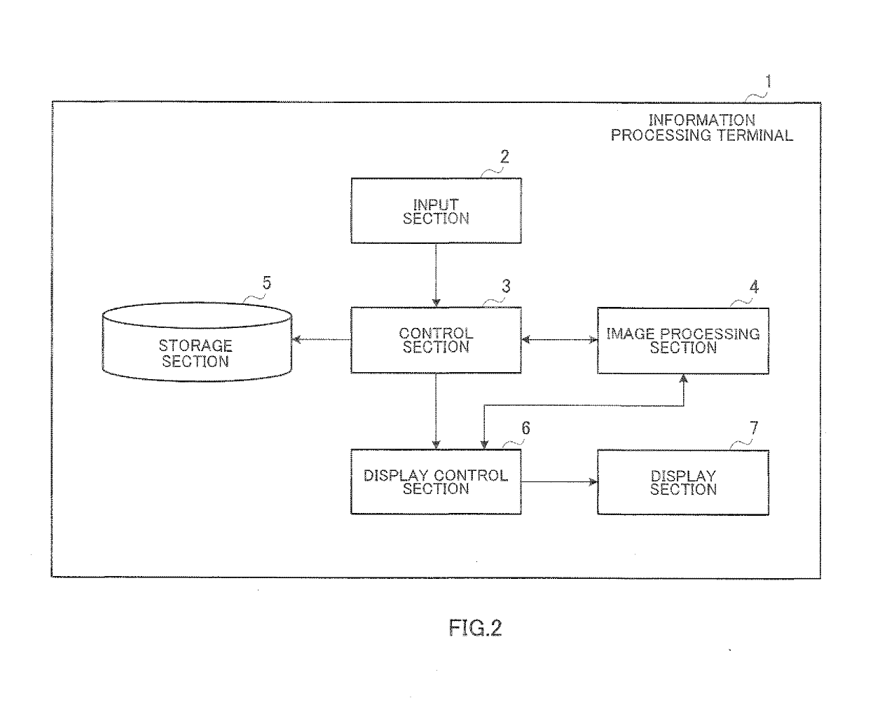

FIG. 2 is a block diagram illustrating the general configuration of an information processing terminal according to Embodiment 1 of the present invention.

As shown in FIG. 2, information processing terminal 1 includes input section 2, control section 3, image processing section 4, storage section 5, display control section 6, and display section 7.

Input section 2 includes various kinds of input devices such as key or touch panel, and transmits input information to control section 3.

Control section 3 receives the input information from input section 2 and transmits a screen capture request for acquiring a screen buffer of an application program managed by display control section 6 to image processing section 4. Further, control section 3 outputs a screen capture image processed by image processing section 4 to storage section 5. Furthermore, when control section 3 is requested to display an application program list screen through input section 2, control section 3 reads the screen capture image stored in storage section 5 and outputs the screen capture image to display control section 6.

Image processing section 4 receives the screen capture request transmitted from control section 3, acquires currently displayed image data from display control section 6, and reduces the size of the image data.

Storage section 5 includes, for example, various kinds of storage devices such as memories and hard disks, associates and stores the application programs with the image data generated by image processing section 4.

Display control section 6 includes an executing screen buffer of an application program and performs display by outputting the executing screen buffer to display section 7. Further, by using the screen capture image output from control section 3, display control section 6 generates the application program list screen and allows display section 7 to display the result.

Display section 7 includes, for example, various kinds of display devices such as liquid crystal displays (LCD), and display control section 6 performs various kinds of display controls when using display section 7.

Hereinafter, a process of information processing terminal 1 configured as above will be described.

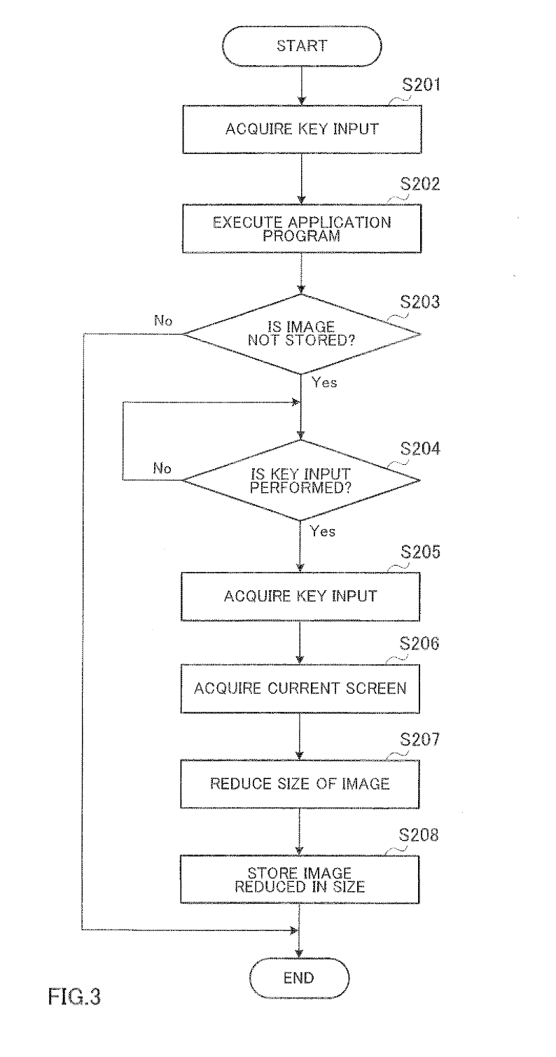

FIG. 3 is a flowchart illustrating a process of acquiring an image in which the title of an application program is displayed in information processing terminal 1.

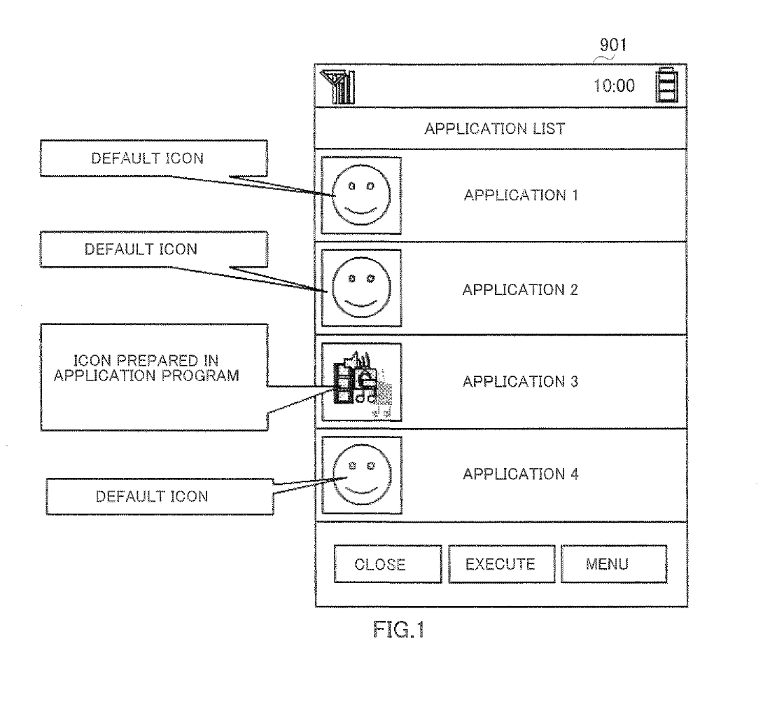

First, in the application program list screen shown in FIG. 1, input section 2 receives a key input corresponding to selection and decision of an application program by a user (step S201).

Next, input section 2 notifies control section 3 of the key input and control section 3 executes the corresponding application program based on the key input (step S202).

Control section 3 determines whether or not an image used in the list of the application programs is stored in storage section 5. When the image is not stored (No in step S203), as in the prior art, the application program list screen is displayed as shown in FIG. 1.

When the image is stored (Yes in step S203), input section 2 determines whether or not the key input is performed (step S204).

When the key input is performed (Yes in step S204), input section 2 notifies control section 3 of input information.

On the other hand, when the key input is not performed (No in step S204), input section 2 determines once again whether or not a key input is performed.

Next, when the key input is performed (Yes in step S204), control section 3 transmits the screen capture request to image processing section 4 (step S205).

Next, image processing section 4 receives the above screen capture request, acquires a currently displayed screen of the application program from display control section 6 (step S206), and converts the acquired screen into an icon image (step S207).

Next, control section 3 stores the icon image generated by image processing section 4 in storage section 5 (step S208).

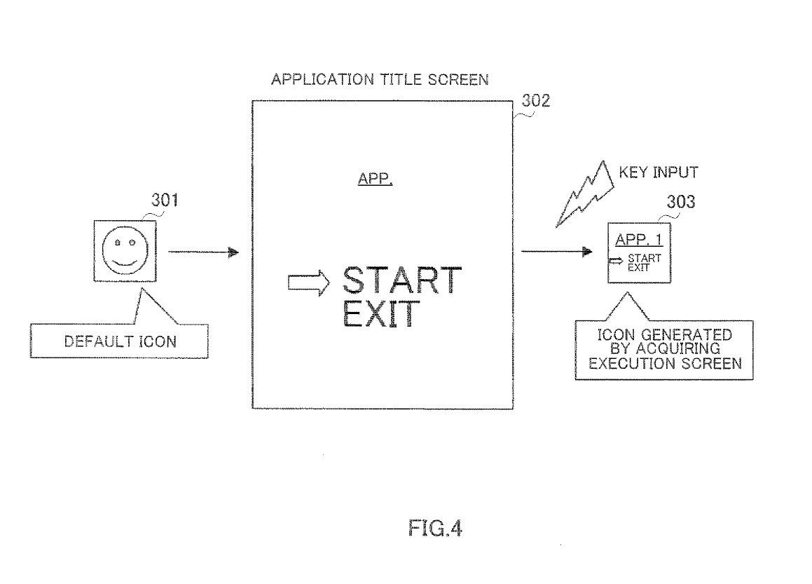

FIG. 4 is an operation image that illustrates a process of acquiring images where the titles of application programs are displayed in information processing terminal 1.

Before executing the flow of FIG. 3, default icon 301 built in the information processing terminal beforehand is used as an icon image on the application list screen (see 901 in FIG. 1).

Title screen 302 is displayed when the application program is selected from the application program list screen and is executed. In general, on the application title screen, the title of the application is displayed by a character, an image, or the like and an operation (for example, a key input) of starting a main function (for example, a game or a tool) of the application is to be received.

Next, when display section 7 displays title screen 302 of the application and when receives an operation by input section 2, image processing section 4 reduces the size of title screen 302 and generates icon image 303.

Although the present embodiment has exemplified the key input in order to generate title screen 302, the present invention is not limited to this, and it is equally possible to be inputs on a touch pad or a touch panel.

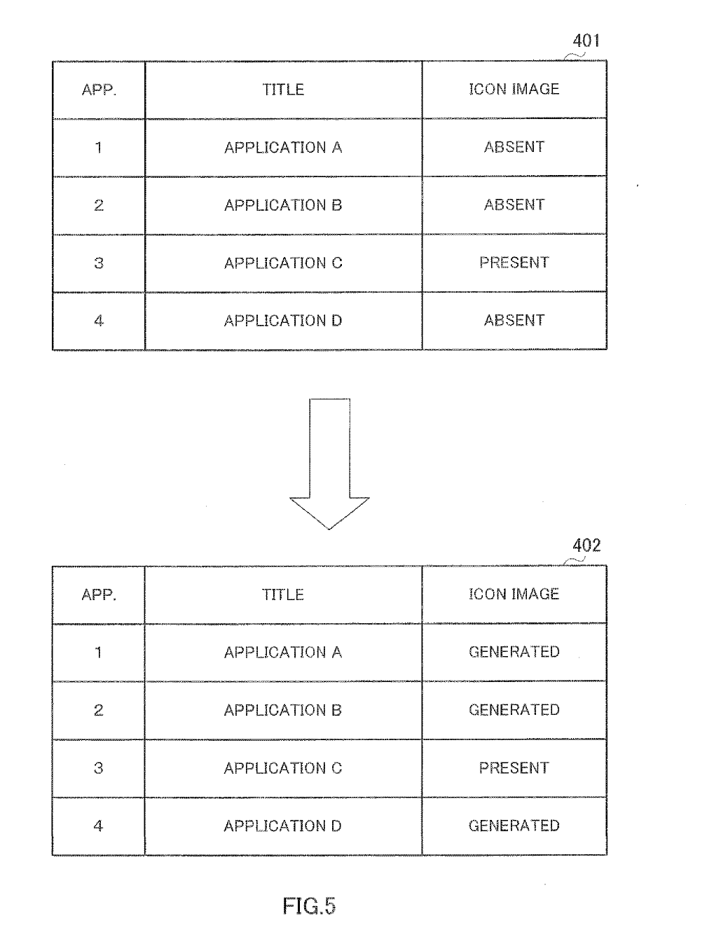

FIG. 5 illustrates a data table stored in storage section 5 of information processing terminal 1.

Data table 401 is a data table before executing the flow of FIG. 3, and stores the title and the icon image of each application associated with each other.

Since the icon images are not generated, the icon images are stored as “absent” in application 1, 2, and 4.

As for application 3, the icon image is prepared in advance in the application program.

Data table 402 is a data table after executing the flow of FIG. 3, and stores the title and the icon image of each application associated with each other.

Since the icon images are generated by executing the flow of FIG. 3, the icon images are stored as “generated” in applications 1, 2, and 4.

Since the icon image is prepared for application 3 in advance in the application program, the icon image is not changed even after executing the flow of FIG. 3.

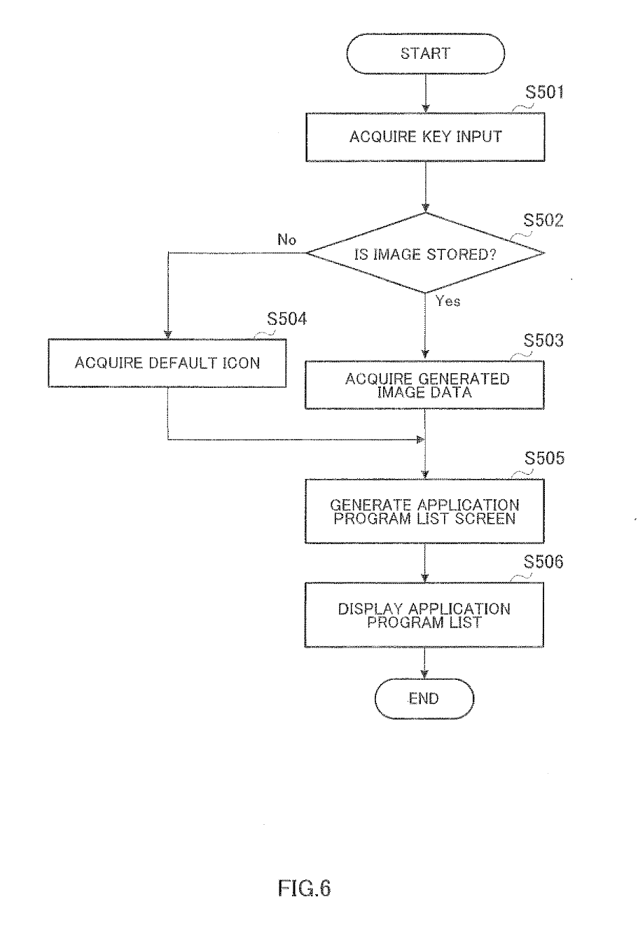

FIG. 6 is a flowchart illustrating a process of displaying a list of the application programs in information processing terminal 1.

Control section 3 first receives the key input from input section 2 (step S501), and confirms whether the icon image is stored in storage section 5 (step S502). Specifically, storage section 5 holds the same data table as data table 401 shown in FIG. 5. When the icon image is stored, control section 3 can determine that the icon image is generated, as in data table 402.

When storage section 5 does not store the image data generated by image processing section 4 (No in step S502), control section 3 acquires a default icon or the icon image of the application (step S504), and generates the application program list screen (step S505).

On the other hand, when storage section 5 stores the image data generated by image processing section 4 (Yes in step S502), control section 3 acquires the icon image (step S503).

Next, display control section 6 generates the application program list screen, based on the image data acquired by control section 3 (step S505).

Next, display section 7 displays the application program list screen generated by display control section 6 (step S506).

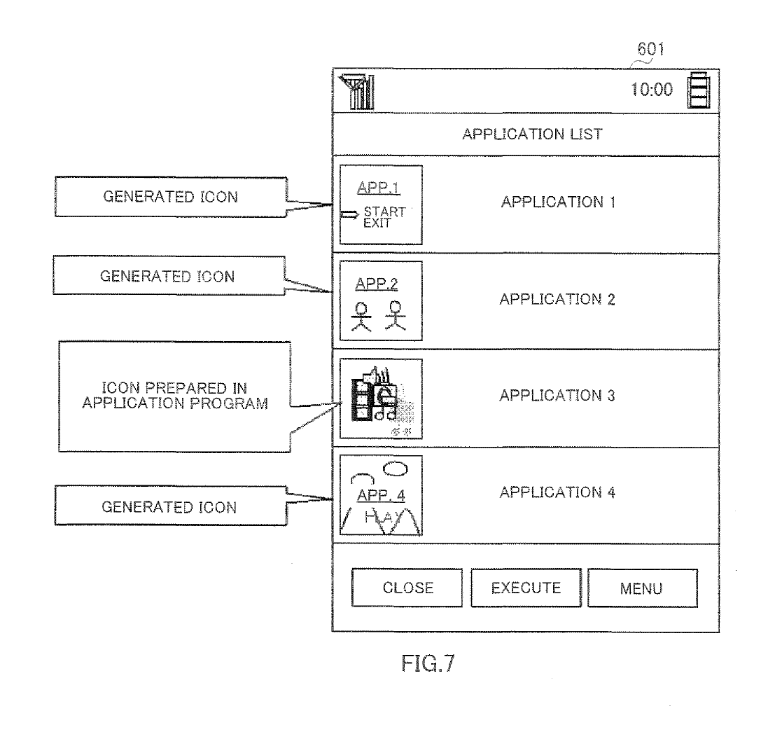

FIG. 7 is a diagram illustrating an example of application program list screen 601 when data table 402 is stored in storage section 5 of information processing terminal 1.

As the processing result of FIG. 6, the default icons of applications 1, 2, and 4 are substituted and displayed by icons that is icons where the sizes of that the title screens of the application programs are reduced. Application 3 displays the icon prepared by application 3.

As described in detail above, information processing terminal 1 according to the present embodiment includes input section 2 that receives an operation input, storage section 5 that stores application programs, and display section 7 that displays a list of the application programs stored in storage section 5. Information processing terminal 1 further includes control section 3 that associates the screens of the application programs displayed on display section 7 with the application programs and stores the screens associated with the application programs in storage section 5 when the application program is executed and when input section 2 receives a specific operation input. Display section 7 displays the screens of the application programs, when input section 2 receives an operation of displaying the list of the application programs.

In this way, it is possible to display the list of the application programs as a screen suitably reflecting the contents of the application programs by acquiring and storing the screen displayed in response to the operation input while executing the application program.

Thus, by accurately acquiring the images in which the titles of the application programs are displayed and displaying the images suitably reflecting the contents of the application programs in the list of the application programs, it is possible to make the contents of each application program easier to understand, the contents being hard to understand with the default icon.

Information processing terminal 1 according to the present embodiment further includes image processing section 4 that reduces the size of the screen of the application program. Display section 7 displays the screen of the application program reduced in size by the image processing section, when the input section receives an operation of displaying the list of the application programs. By this means, it is possible to adjust an image displayed in the list of the application programs to arbitrary sizes.

### Embodiment 2

In general, the following process is performed as a process of reaching the title screen of an application program or a process performed during display of the title screen.

Examples of the process of reaching the title screen of an application program include a communication process of acquiring image data necessary for the application program from the Internet or the like, a file accessing process of storing the acquired image data as a file in the information processing terminal or retrieving the acquired image data, and a loading screen displaying process of displaying characters such as “loading” by embedding a screen with a mono-color such as black or white as a loading screen during the communication process or the file accessing process.

An example of the process performed during display of the title screen includes a speech reproducing process.

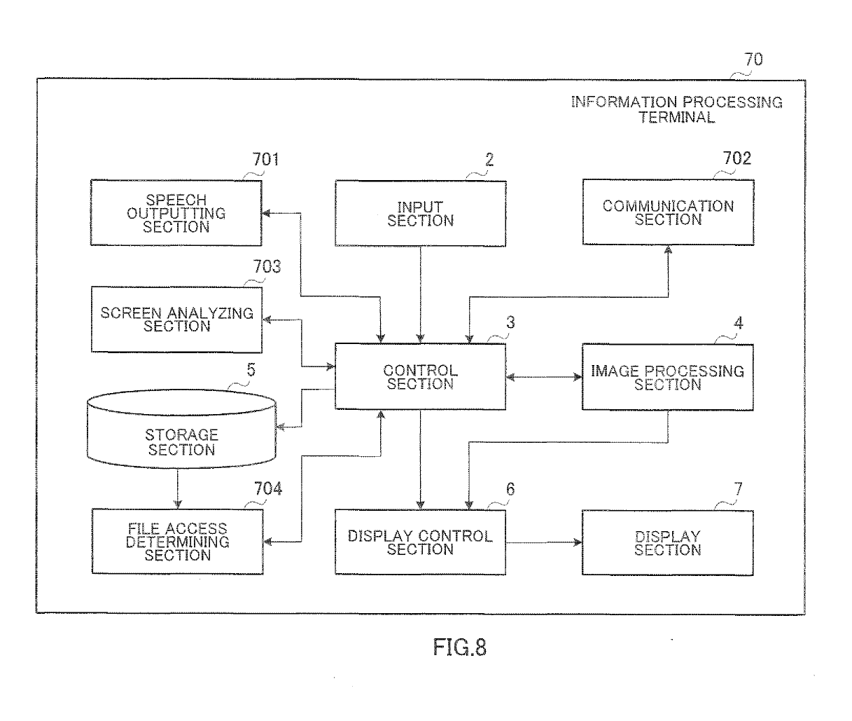

FIG. 8 is a block diagram illustrating the general configuration of an information processing terminal according to Embodiment 2 of the present invention. The same reference numerals are given to the same constituent elements as those in FIG. 1 and the descriptions thereof will be omitted.

Information processing terminal 70 according to the present embodiment has a feature in that the configuration of information processing terminal 1 according to Embodiment 1 newly includes speech outputting section 701, communication section 702, screen analyzing section 703, and file access determining section 704, and improves the accuracy of image acquisition on the screens where titles are displayed.

Speech outputting section 701 determines whether or not an executed application program is outputting speech. Speech outputting section 701 has, for example, a speaker or earphone output, so that it is possible to output speech data transmitted from the application program.

Furthermore, speech outputting section 701 maintains the current output state.

Communication section 702 determines whether or not an executed application program is performing communication. For example, communication section 702 can access a server through the Internet and thus can keep a communication result or a communication state.

Screen analyzing section 703 analyzes a screen displayed by the executed application program and determines whether or not the same color is continuous. Screen analyzing section 703 can examine the features of the image data, when the image data is presented. For example, screen analyzing section 703 can calculate information indicating a ratio of a black part to the entire image.

File access determining section 704 determines whether or not the executed application program is performing file access. File access determining section 704 determines whether or not storage section 5 is performing file access and returns the result.

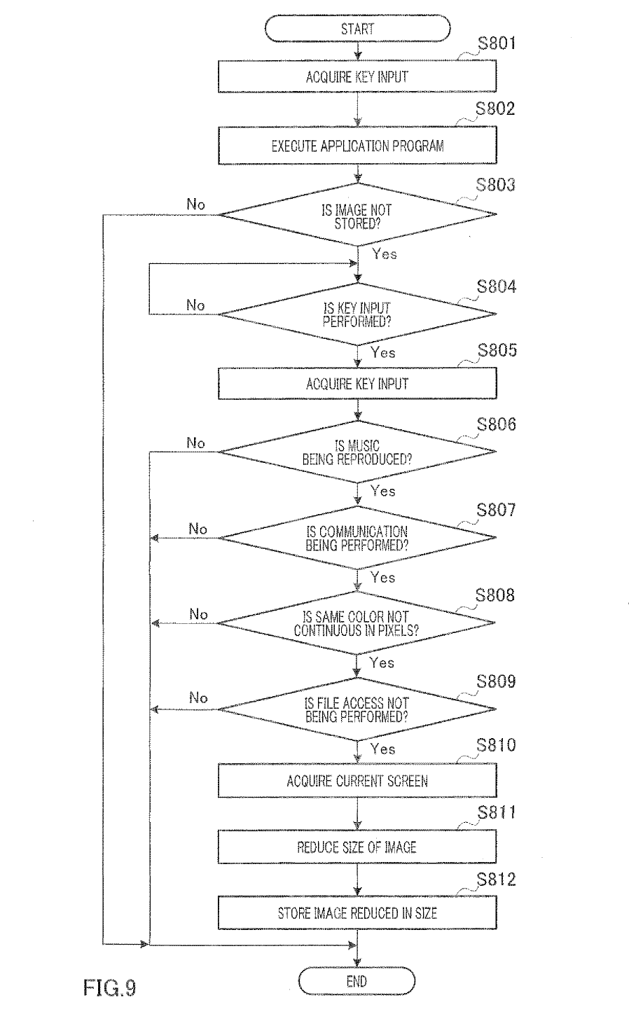

FIG. 9 is a flowchart illustrating a process of acquiring the images in which the titles of the application programs are displayed in information processing terminal 70.

Since steps S801 to S805 that are processes of the key input in response to a screen capture request from executing an application program are the same as steps S201 to S205 of FIG. 3, the descriptions thereof will be omitted. Since steps S810 to S812 that are processes for acquiring and storing an image currently displayed by the application program are the same as step S206 to S208 of FIG. 3, the descriptions thereof will be omitted.

Hereinafter, a flow of steps S805 to S810 will be described.

When the key input is acquired (step S805), control section 3 first confirms whether speech outputting section 701 is reproducing music (step S806).

Next, when speech outputting section 701 is reproducing the music (Yes in step S806), control section 3 confirms whether communication section 702 is performing communication (step S807).

On the other hand, when speech outputting section 701 is not reproducing the music (No in step S806), the process does not proceed and ends.

Next, when communication section 702 is performing the communication (Yes in step S807), control section 3 allows screen analyzing section 703 to confirm whether or not the same color is not continuous in the screen (step S808). Specifically, screen analyzing section 703 picks up pixels of the acquired image data one by one, and stores the result in a temporary region if there is a pixel having the same color. Screen analyzing section 703 resets the temporary region at the point when the pixels having different colors are found. When a certain number of pixels is accumulated in the temporary region, it is determined that the same color is continuous. The temporary region is created in storage section 5 through control section 3.

On the other hand, when communication section 702 is not performing the communication (NO in step S807), the process does not proceed and ends.

Next, when screen analyzing section 703 determines that the same color is not continuous in the image data of the application program displayed on the display section (Yes in step S808), control section 3 allows file access determining section 704 to confirm whether file access is being performed (step S809).

On the other hand, when screen analyzing section 703 determines that the same color is continuous in the image data of the application program displayed on the display section (No in step S808), the process does not proceed and ends.

Next, when file access determining section 704 confirms that the file access to storage section 5 is not being performed (Yes in step S809), control section 3 transmits the screen capture request to image processing section 4 (step S810).

On the other hand, when file access determining section 704 confirms that the file access to storage section 5 is being performed (No in step S809), the process does not proceed and ends.

Next, image processing section 4 receives the screen capture request and acquires the currently displayed screen of the application program (step S810).

According to the present embodiment, information processing terminal 70 further includes speech outputting section 701, communication section 702, screen analyzing section 703, and file access determining section 704. Speech outputting section 701, communication section 702, screen analyzing section 703, and file access determining section 704 are configured to improve the accuracy by determining the conditions displayed on the title screen, and thus can display the images suitably reflecting the contents of the application programs in the list of the application programs. Specifically, the following advantages can be obtained.

(1) Information processing terminal 70 includes speech outputting section 701 that determines whether or not the executed application program is outputting speech. When speech outputting section 701 determines that the application program is outputting the speech and input section 2 receives a specific operation input, control section 3 stores the screen of the application program displayed on display section 7 in storage section 5. Further, when speech outputting section 701 determines that the application program is not outputting the speech and input section 2 receives the specific operation input, control section 3 does not store the screen of the application program displayed on display section 7 in storage section 5.

Thus, it is possible to increase the probability that the acquired image is the title screen most suitably reflecting the contents of the application program.

(2) Information processing terminal 70 includes communication section 702 that determines whether or not the executed application program is performing the communication. When communication section 702 determines that the application program is not performing the communication and when input section 2 receives a specific operation input, control section 3 stores the screen of the application program displayed on display section 7 in storage section 5. Further, when communication section 702 determines that the application program is performing the communication and when input section 2 receives the specific operation input, control section 3 does not store the screen of the application program displayed on display section 7 in the storage section.

According to this configuration, it is possible to increase the probability that the acquired image is the title screen most suitably reflecting the contents of the application program.

(3) Information processing terminal 70 includes screen analyzing section 703 that analyzes the screen displayed by the executed application program and determines whether or not the same color is continuous. When screen analyzing section 703 determines that the same color is not continuous in the screen displayed by the application program and input section 2 receives a specific operation input, control section 3 stores the screen of the application program displayed on display section 7 in storage section 5. Further, when screen analyzing section 703 determines that the same color is continuous in the screen displayed by the application program and input section 2 receives the specific operation input, control section 3 does not store the screen of the application program displayed on display section 7 in storage section 5.

Thus, it is possible to increase the probability that the acquired image is the title screen most suitably reflecting the contents of the application program.

(4) Information processing terminal 70 includes file access determining section 704 that determines whether or not the executed application program is performing file access. When file access determining section 704 determines that the application program is not performing file access and input section 2 receives a specific operation input, control section 3 stores the screen of the application program displayed on display section 7 in storage section 5. Further, when file access determining section 704 determines that the application program is performing the file access and input section 2 receives the specific operation input, control section 3 does not store the screen of the application program displayed on display section 7 in storage section 5.

Thus, it is possible to increase the probability that the acquired image is the title screen most suitably reflecting the contents of the application program.

The disclosure of Japanese Patent Application No. 2009-169886 filed on Jul. 21, 2009, including the specification, drawings and abstract, is incorporated herein by reference in its entirety.

### INDUSTRIAL APPLICABILITY

An information processing terminal according to the invention is capable of displaying images suitably reflecting the contents of application programs in the list of the application programs. Accordingly, the information processing terminal is applicable to a portable telephone or a portable PC configured to select an application program from a displayed list of the application programs and execute the application program.

### REFERENCE SIGNS LIST

1, 70 Information processing terminal
2 Input section
3 Control section
4 Image processing section
5 Storage section
6 Display control section
7 Display section
701 Speech outputting section
702 Communication section
703 Screen analyzing section
704 File access determining section

1-6. (canceled)

7. An information processing terminal comprising:
an input section that receives an operation input;
a storage section that stores application programs;
a display section that displays a list of the application programs stored in the storage section;
a control section that associates screens of the application programs displayed on the display section with the application programs and stores the screens in the storage section when the application programs are executed and when the input section receives a specific operation input; and
a speech outputting section that determines whether or not the application programs being executed are outputting speech, wherein:
the display section displays the screens of the application programs when the input section receives an operation of displaying the list of the application programs; and
the control section stores the screens of the application programs displayed on the display section in the storage section when the speech outputting section determines that the application programs are outputting speech and when the input section receives the specific operation input, whereas the control section does not store the screens of the application programs displayed on the display section in the storage section when the speech outputting section determines that the application programs are not outputting speech and when the input section receives the specific operation input.

8. An information processing terminal comprising:
an input section that receives an operation input;
a storage section that stores application programs;
a display section that displays a list of the application programs stored in the storage section;
a control section that associates screens of the application programs displayed on the display section with the application programs and stores the screens in the storage section when the application programs are executed and when the input section receives a specific operation input; and
a communication section that determines whether or not the application programs being executed is performing communication,
wherein the control section stores the screens of the application programs displayed on the display section in the storage section when the communication section determines that the application programs are not performing communication and when the input section receives the specific operation input, whereas the control section does not store the screens of the application programs displayed on the display section in the storage section when the communication section determines that the application programs are performing communication and when the input section receives the specific operation input.

9. An information processing terminal comprising:
an input section that receives an operation input;
a storage section that stores application programs;
a display section that displays a list of the application programs stored in the storage section;
a control section that associates screens of the application programs displayed on the display section with the application programs and stores the screens in the storage section when the application programs are executed and when the input section receives a specific operation input; and
an image analyzing section that analyzes screens displayed by the application programs being executed and determines whether or not the same color is continuous,
wherein the control section stores the screens of the application programs displayed on the display section in the storage section when the image analyzing section determines that the same color is not continuous in the screens displayed by the application programs and when the input section receives the specific operation input, whereas the control section does not store the screens of the application programs displayed on the display section in the storage section when the image analyzing section determines that the same color is continuous in the screens displayed by the application programs and when the input section receives the specific operation input.

10. An information processing terminal comprising:
an input section that receives an operation input;
a storage section that stores application programs;
a display section that displays a list of the application programs stored in the storage section;
a control section that associates screens of the application programs displayed on the display section with the application programs and stores the screens in the storage section when the application programs are executed and when the input section receives a specific operation input; and
a file access determining section that determines whether or not the application programs being executed is performing file access,
wherein the control section stores the screens of the application programs displayed on the display section in the storage section when the file access determining section determines that the application programs are not performing file access and when the input section receives the specific operation input, whereas the control section does not store the screens of the application programs displayed on the display section in the storage section when the file access determining section determines that the application programs are performing the file access and when the input section receives the specific operation input.
